(19) United States
(12) Patent Application Publication
(10) Pub. No.: US 2003/0079403 A1
(43) Pub. Date: May 1, 2003

(54) Clover sprouting culture & packaging dish

(76) Inventor: Lin-Chia Hsien, Taipei City (TW)

Correspondence Address: Lin-Chia Hsien, PO Box 82-144, Taipei, TW

(21) Appl. No.: 09/983,909

(22) Filed: Oct. 26, 2001

(51) Int. Cl. A01G 31/00

(52) U.S. Cl. 47/61

(57) ABSTRACT

A clover sprouting culture and packaging dish, comprised of a dish and a lid, a gauge on the bottom with seeds evenly sprayed upon it, then the dish is moved into culture room and maintained its moisture by regular water spray; the dish finally is covered up with the lid and delivered saving any further washing and packaging directly to the market fresh and green for sales without damaging the sprouts.

### BACKGROUND OF THE INVENTION

1. Field of the Invention

The present invention relates to a clover sprouting culture and packaging dish, and more particularly, to one that upon completing the culture can be directly delivered to market for sales.

2. Description of the Prior Art

People tend to eat more of the vegetables that rich in fibers due to their physical mechanism has been threatened by over nutrition and obesity when the junk food is to blame. However, abuse of pesticides to make sure that the green grows larger and looks better also present another form of hazard to our health. Recently, nutritionists for being more environment awareness have been promoting organic diet and suddenly, natural food such as the clover sprouts, and wheat sprouts becomes hot commodity in the market. People buy natural food and either eat it without cooking or mix it into juice for drinking. Natural food proves to be healthy, environment-friendly, helping improve one's beauty, and offering significant benefit to regulate one's physical mechanism. Accordingly, dedicated shops selling natural food can be seen around the corner.

As far as the clover sprout is concerned, those generally available in traditional dry market or shopping mall are like the one as illustrated in FIG. 1 of the accompanying drawings. Seeds are first sprayed over a culture dish (1), then left in a culture room for sprouting at a temperature controlled at slightly lower than the ambient temperature. The growth period takes approximately ten days for the clover to grow to an edible height (approximately 8 cm). When fetched from the culture room, the clover sprouts must be washed by manual and plugged out one by one, rinsed, picked and sorted before delivery to the market for sales. However, the sprouts are damaged and stop to grow after having been picked up from the culture dishes, thus start to wither to prevent from transportation and storage. As a result, it is very difficult to keep the clover sprout maintaining fresh. Since the consumer usually takes the clover sprouts without cooking them, he must eat them up soonest upon arriving at home. Besides, the clover sprouts are packed in PE bags and the temperature inside the PE bags will rise due to friction and compaction in transit. Higher temperature is detrimental to the transportation and sales standards for the perishable. Simply by visual inspection, it can be observed that the clover sprouts in said PE bags already to show signs of withering, no more freshness and damaged appearance.

### SUMMARY OF THE INVENTION

The present invention relates to a clover sprouting culture and packaging dish, and more particularly, to one that upon completing the culture can be directly delivered to market for sales.

The primary purpose of the present invention is to provide a culture dish with a lid for growing clover sprouts and the dish itself serves a packing unit so that the sprouts are grown, packed and delivered to the market all in the same dish to maintain always fresh when bought by the consumer. The present invention being simple in structure and enormous for its effects complies with the mass production purpose for the trade. To achieve the purpose, gauze is placed at the bottom of the dish and clover seeds are evenly distributed on said gauze. The uncovered dish then is moved into a culture room to grow and wetted regularly to maintain its moisture. Upon the sprouts grow to an edible height, the culture dish is covered up with the lid, stacked up with other dishes and forthwith delivered to the market for sales without damaging the sprouts.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a culture dish of the prior art.

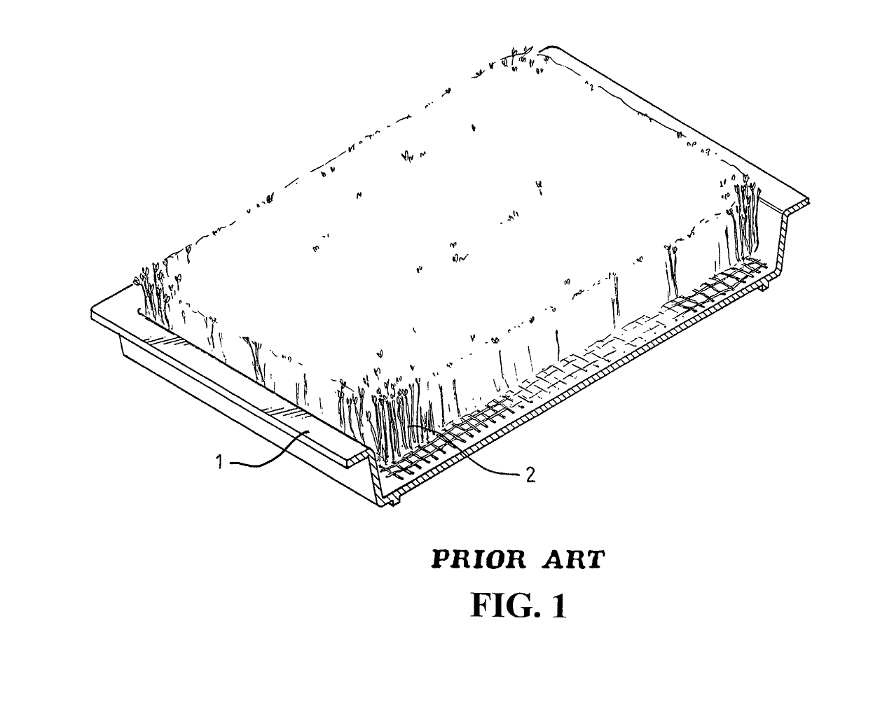

FIG. 2 is an exploded view of a preferred embodiment of the present invention.

FIG. 3 is a sectional view of the preferred embodiment of the present invention.

FIG. 4 is schematic view showing that the preferred embodiment is ready for shipment.

### DETAILED DESCRIPTION OF THE PREFERRED EMBODIMENTS

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

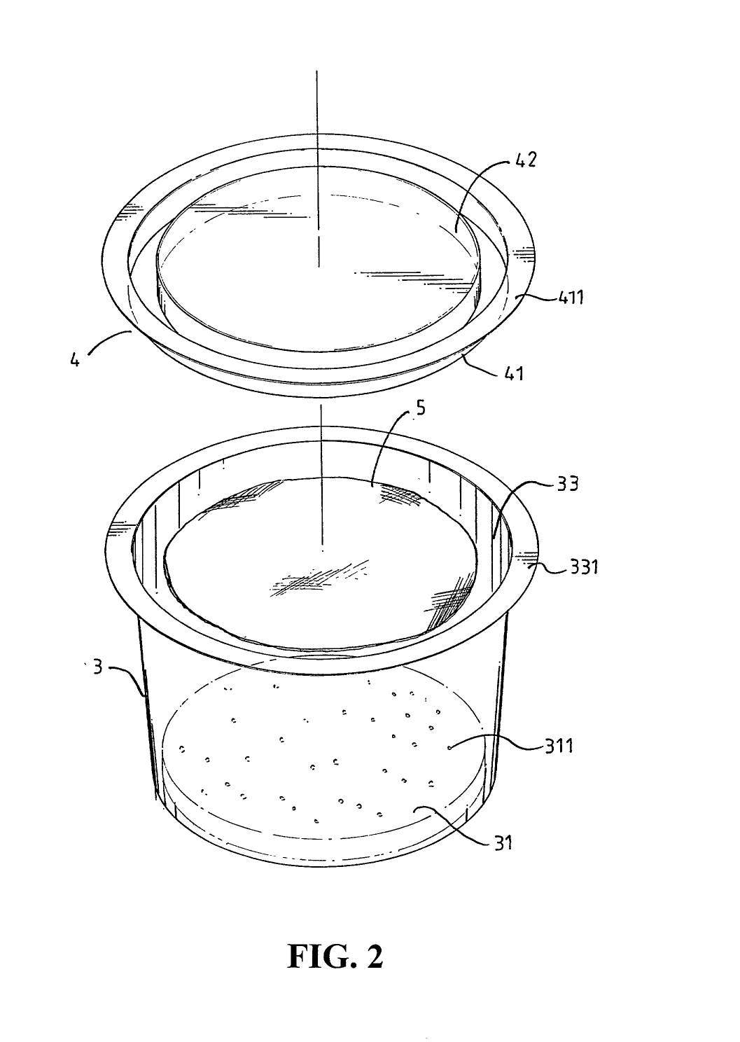

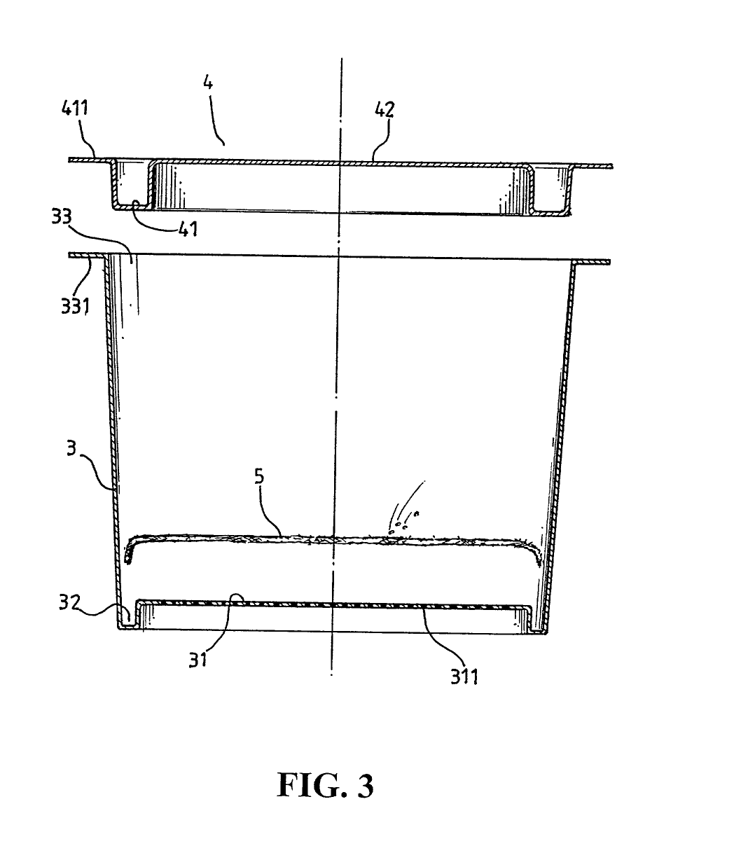

Referring to FIGS. 2 and 3, a preferred embodiment of the present invention of a clover sprout culture and packaging dish is essentially comprised of a dish (3) and a lid (4). Both of said dish (3) and lid (4) are directly formed by injection mold with petrol-chemical materials such as PS, PVC, PE or PEP. Said dish (3) relates to one having taller wall at a height variable depending on the species of the plant to be grown (such as wheat, green beans) and may be made in circular, square, rectangular, triangle or oval shape. A groove (32) in depth of approximately 10 cm is formed on the circumference of the bottom (31) of the dish (3) for conservation of water containment with an area it covers slightly smaller than that of the bottom (31) of the dish (3). Multiples of pore (311) are evenly provided above the bottom (31) of the dish (3) for ventilation and drainage. A gauze (5) is placed over those pores (311). A flange (331) is provided at the mouth (33) of the dish (3) corresponding to a mating flange (411) provided on the lid (4) which seals up the dish (3) by packing the mouth (33) of the dish (3) with the edge (41) of the lid (4). A convex portion (42) is provided in the center of the lid (4) with an area slightly than that of the bottom (31) of the dish (3).

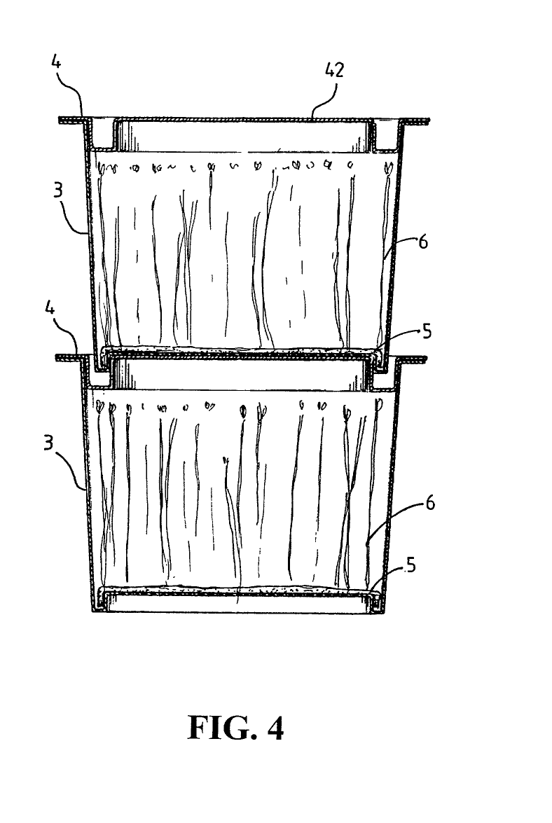

In practice using those members disclosed above, the gauze (5) (or other water absorption fabric) is first placed on the bottom (31) of the dish (3) with the gauze (3) partially extending into the groove (32). Clover seeds are evenly sprayed on the gauze (5) and the uncovered dish (3) is moved to the culture room provided with an automatic temperature control system. Excessive water containment is expelled through those pores (311) while a proper amount of water containment is conserved in the groove (32) to prevent the clover from being draught or rotten. Upon clover sprouts (6) grow to an edible height, the dish (3) leaves the culture room and covered up with the lid (4) to complete the packaging process. As illustrated in FIG. 4, the culture dishes (3) are stacked up to consume the least storage place and to ensure that the finish products are intact.

By comparing to the prior art, the present invention offers the following advantages:

1. All processes of sowing the seeds, growing, cropping and packing for the clover sprouts are done in the same culture dish that significantly saves the complicate cropping process.

2. The gauze used in the present invention facilitates the growth of the clover sprouts, offer stronger attachment for the roots of the clover to ensure consistent growth of the sprouts and prevent roots from leaving while protecting the roots from being damaged and maintaining the sprouts always in fresh before taken by the consumer.

3. The present invention permits the culture dish to be stacked up with other dishes for saving space, easy packaging for delivery and assurance of integrity of the finished product.

The present invention for being simple in structure and easy production and allowing the entire cycle of sowing, growing, packaging and sales of the clover sprouts all done in the same culture dish and the same culture dish reaching the hands of the consumer as fresh and intact, is innovative and practical in meeting elements of a utility paten. Therefore, this application for a utility patent is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A clover sprouting culture and packaging dish comprised of a dish and a lid; an approximately 10 cm deep groove being formed from the bottom of the disk with the area covered by the groove slightly less than that of the bottom of the dish; multiples of pore being evenly distributed on the bottom; a water absorption fabric covering up those pores; a flange being provided on the circumference of the mouth of the dish corresponding to another flange provided on the circumference of the lid; and the central area of the lid being convex with the area of the convex slightly less than that of the bottom of the dish.

2. A clover sprouting culture and packaging dish as claimed in claim 1, wherein, the flange of the lid fully packs up the mouth of the dish and merely couples the bottom of another disk stacking upon it for packaging purpose.

3. A clover sprouting culture and packaging dish as claimed in claim 1, wherein, the dish may be in a circular, square, rectangular, triangle, or oval shape.

4. A clover sprouting culture and packaging dish as claimed in claim 1, wherein, the height of the dish may vary depending on the species of the plant of culture.

5. A clover sprouting culture and packaging dish as claimed in claim 1, wherein, the gauge relates to a fabric giving excellent water absorption.
